(19) United States
(12) Patent Application Publication
(10) Pub. No.: US 2026/0364728 A1
(43) Pub. Date: Nov. 19, 2026

(54) MACHINE TOOL WITH COOLING DEVICE

(71) Applicant: P&L GmbH & Co. KG, Soltau (DE)

(72) Inventor: Jürgen RÖDERS, Soltau (DE)

(21) Appl. No.: 19/132,210

(22) PCT Filed: Nov. 27, 2023
(86) PCT No.: PCT/EP2023/083211

§ 371 Date: May 22, 2025

(30) Foreign Application Priority Data
Dec. 1, 2022 (DE) 10 2022 131 884.2

(51) Int. Cl. B23Q 11/12; B23Q 1/52

(52) U.S. Cl. CPC B23Q 11/128; B23Q 1/522; B23Q 2220/004

(57) ABSTRACT

The invention relates to a machine tool comprising a rotary table having a table plane, wherein the rotary table is rotatable about an axis of rotation. Furthermore, the machine tool comprises a bearing which mounts the rotary table on a housing and a cooling device having a cooling channel configured for a coolant to flow therethrough. In this case, a gap is present between the cooling device and the rotary table, which ensures a rotatability of the rotary table. The machine tool is characterized in that the cooling device is arranged between the table plane and a bearing plane which extends through a center of the bearing.

### CROSS-REFERENCE TO RELATED APPLICATIONS

This application is a national phase filing under 35 U.S.C. § 371 of International Application No. PCT/EP 2023/083211, filed on Nov. 27, 2023, which claims priority to German Patent Application No. DE 102022131884.2, filed on Dec. 1, 2022, the entire content of each application is incorporated by reference herein.

### FIELD OF THE DISCLOSURE

The invention relates to a machine tool comprising a cooling device.

### BACKGROUND OF THE DISCLOSURE

In the machine tool industry, there has long been a trend towards shortening processing times. This situation results in high-speed machining and ever faster processing steps. At the same time, it is desirable to improve the processing accuracy of the workpieces. However, the high processing speeds lead to increased heating of the workpiece and the machine components. The resulting thermal heating of the components leads to an uncontrolled length extension and warpage, which has a negative effect on the processing quality.

Rotary tables allow for receiving of a workpiece and the processing thereof from different sides. In this case, above all the bearing of the rotary table, but also its drive unit, is subject to heating, inter alia on account of friction, during the workpiece processing. Due to the direct contact with the workpiece, the heating can be transmitted via the table to the workpiece. In this case, the heating of the rotary table has a negative impact on the processing accuracy of the machine tool.

### SUMMARY OF THE DISCLOSURE

The present disclosure provides, in one aspect, a machine tool including a rotary table having a table plane, wherein the rotary table is rotatable about an axis of rotation, a bearing which mounts the rotary table on a housing, and a cooling device having a cooling channel, configured for a coolant to flow therethrough, wherein a gap is present between the cooling device and the rotary table, which ensures a rotatability of the rotary table, and wherein the cooling device is arranged between the table plane and a bearing plane which extends through a center of the bearing.

Other features and aspects of the subject matter will become apparent by consideration of the following detailed description and accompanying drawings.

### BRIEF DESCRIPTION OF THE DRAWINGS

FIG. 1 is a section view of a portion of the machine tool, including the rotary table.

FIG. 2 is an enlarged section view of the machine tool of FIG. 1, including the cooling device.

### DETAILED DESCRIPTION

The machine tool 1 comprises a rotary table 2 which is a rotationally symmetrical component and which is configured to rotate about an axis of rotation X-X. The rotary table is connected to a housing 4 via a bearing 3. The housing 4 is configured as the C-axis of the machine tool 1.

A table surface 22 having a planar table plane T is attached, via a screw connection, at a first end along the axis of rotation X-X of the rotary table 2. The table surface 22 is configured for receiving a workpiece for processing using the machine tool 1. Alternatively, the rotary table 2 can also be configured in one piece, having an integral table surface 22.

The rotary table 2 is connected to the housing 4 via the bearing 3. Furthermore, a cooling device 5 is arranged between a bearing plane L, which extends through a center of the bearing 3, and the table plane T. The cooling device 5 extends in an annular manner around the axis of rotation X-X of the rotary table 2. In this case, a gap 6 is present between the rotary table 2 and the cooling device 5, which gap ensures the rotatability of the rotary table 2.

The bearing 3 is made up of an inner ring 31, an outer ring 32, and cylindrical rollers 33. In the embodiment, the bearing 3 is configured as an axial/radial cylindrical roller bearing. Due to the axial and radial orientation of the cylindrical rollers 33, the bearing 3 is characterized by very high strength and tilting stability, and achieves high precision in axial and radial runout. The inner ring 31 connected to the rotary table 2 is formed in two parts and has a C-shaped cross-section, which axially surrounds the outer ring 32. The outer ring 32 is fastened to the housing 4 via a screw connection. Depending on the requirements profile, the bearing 3 can also be configured in another construction.

The rotary table 2 is directly electrically driven. For this purpose, a rotor 23 is attached below the bearing 3, on the rotary table 2, in the direction of a second end of the axis of rotation X-X opposite the table plane. On the housing 4, a stator 41 is attached to the rotor 23, with a surrounding gap 6, which stator electromechanically drives the rotor 23. Alternatively, a direct mechanical drive of the rotary table 2 is also conceivable, for example via a transmission. In particular, the stator 41 of the electric drive preferably has an independent cooling device.

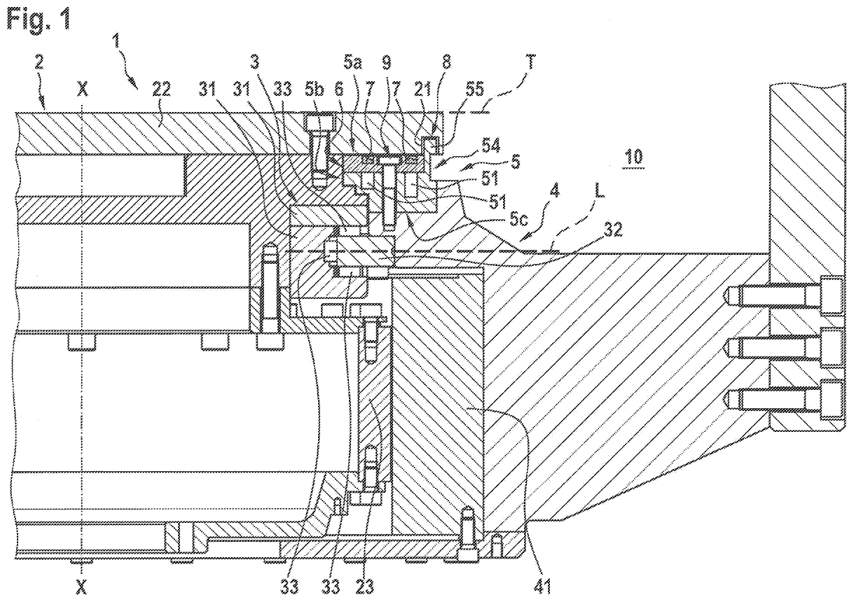

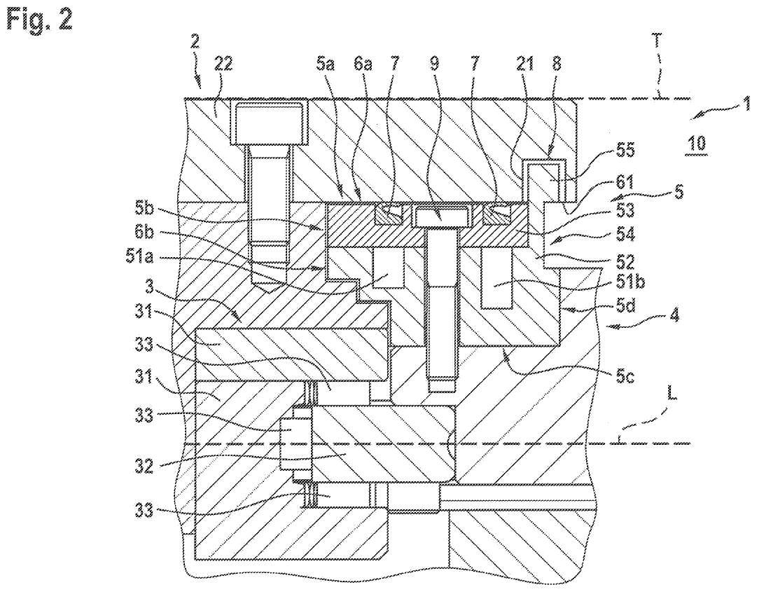

The cooling device 5 from FIG. 1 is shown in detail in FIG. 2. This is arranged on the housing 4, adjacent to the table surface 22. The cooling device 5 has a first side 5a which is oriented in parallel with the table plane T in the direction of a first gap region 6a, and a second side 5b which extends in parallel with the axis of rotation X-X and is oriented in the direction of the second gap region 6b. A third side 5c extends in parallel with the table plane T and is oriented in the direction of the housing 4. A last fourth side 5d extends in parallel with the axis of rotation X-X and is oriented radially outwards.

On the second side 5b, the cooling device 5 comprises two steps, which enlarge the heat-exchange surface. A step-shaped second gap region 6b forms due to the associated step structure in the rotary table 2. The step structure can also comprise more than two steps. The surface-enlarging structure in the second gap region 6b can also be of other shapes, such as a wave shape. In order to be able to further increase the heat exchange, the cooling device 5 and the rotary table 2 can also have a surface-enlarging structure in the first gap region 6a.

The cooling device 5 is made up of a main body 52 and a cover 53. In this case, the cover 53 is connected to the main body 52 via a screw connection 9. The screw connection 9 furthermore fixes the main body 52, via the third side 5c, on the housing 4, in a hole with a thread. In this case, the main body 52 rests flush on the housing 4.

The screw head is embedded into the cover 53 such that the screw connection 9 does not have any influence on the first gap region 6a. Alternatively, the cooling device 5 can for example also be welded, soldered, pressed or adhesively bonded to the housing 4. The cooling device 5 can also be configured without a cover 53 as a component having an integrated cooling channel 51 and produced for example by casting or additively.

A first cooling channel 51a and a second cooling channel 51b are integrated in the main body 52. The first cooling channel is arranged closer to the axis of rotation X-X than the second cooling channel 51b. In this case, the first cooling channel 51a is preferably a flow and the second cooling channel 51b a return.

The cooling channel 51 can also consist only of a single channel or of a plurality of channels in the cooling device 5. In FIGS. 1 and 2 the cooling channel 51 is rectangular, which results in simple producibility. Alternatively, the cooling channel 51 can also be of any other shapes. A fluid flows through the cooling channel 51, which fluid can for example be water or a special cooling fluid. In this case, on the one hand the cooling channel 51 should have the largest possible contact surface with the main body 52 of the cooling device 5, in order to allow for a high level of heat exchange, and on the other hand should have the least possible pressure loss along the cooling channel 51. A turbulent flow guidance through the cooling channel 51 allows a quick uptake of the thermal energy into the fluid flowing through the cooling channel 51.

Two contact seals 7 are integrated in grooves, in the cover 53, to the left and right of the screw connection, which seals are configured as lip seals. The contact seals 7 rest on the table surface 22 of the rotary table 2 and seal the first gap region 6a with respect to the working chamber 10. The contact seal 7 could also be attached in a groove in the rotary table 2 or the table surface 22 and rest against the cooling device 5. Depending on the sealing requirements, it would also be possible for only one or more than two lip seals to be integrated into the gap 6.

In the embodiment according to the invention, the main body has a dirt capture groove 54 on the fourth side 5d, which groove adjoins the working chamber 10. The aim of the dirt capture groove 54 is to keep the particles coming free in the working chamber during the processing, and the cooling lubricant, away from the opening of the gap 61. This is achieved by the notch, which results in a shoulder to the opening of the gap 61, such that particles or cooling lubricant are not conducted directly into the opening of the gap 61. In this case, the opening of the gap 61 opens perpendicularly to the table plane T, into the dirt capture groove 54. Furthermore, a groove 21 is provided in the table surface 22, which groove results in a U-shaped gap portion. Analogously to the groove 21, the cooling device 5 comprises an annular flange 55.

Thus, a labyrinth seal 8 is formed in the first gap region 6a, directly after the opening of the gap 61, by the groove 21 and the annular flange 55, which labyrinth seal further prevents the penetration of dirt.

A machine tool 1 thus results having a rotary table 2 and a cooling device 5, which controls the temperature of the rotary table 2 and keeps as constant as possible. Furthermore, the machine tool 1 comprising the cooling device 5 is simple and cost-effective to produce.

In addition to the above written description of the invention, regarding the further disclosure thereof reference is hereby explicitly made to the illustrative drawings of the invention in FIG. 1 to 2.

1. A machine tool comprising:
a rotary table having a table plane, wherein the rotary table is rotatable about an axis of rotation;
a bearing which mounts the rotary table on a housing; and
a cooling device having a cooling channel, configured for a coolant to flow therethrough,
wherein a gap is present between the cooling device and the rotary table which ensures a rotatability of the rotary table, and
wherein the cooling device is arranged between the table plane and a bearing plane which extends through a center of the bearing.

2. The machine tool according to claim 1, wherein the gap comprises a first gap region on a first side of the cooling device and a second gap region on a second side of the cooling device.

3. The machine tool according to claim 2, wherein the cooling device is configured, on a third side, for cooling the housing.

4. The machine tool according to claim 1, wherein the cooling device includes a main body, in which the cooling channel is formed, and a cover.

5. The machine tool according to claim 2, wherein the second gap region is configured to be step-shaped.

6. The machine tool according to claim 2, wherein a contact seal is arranged in the gap.

7. The machine tool according to claim 6, wherein the contact seal is arranged in the first gap region.

8. The machine tool according to claim 2, wherein a labyrinth seal is arranged in the first gap region.

9. The machine tool according to claim 8, wherein the labyrinth seal is formed by a protruding annular flange of the cooling device and a groove in the rotary table.

10. The machine tool according to claim 1, wherein the cooling device includes a dirt capture groove on an outside.

11. The machine tool according to claim 10, wherein the cooling device is in direct contact with a working chamber of the machine tool exclusively on the dirt capture groove.

12. The machine tool according to claim 4, wherein the cover is fixed to the main body by means of a screw connection wherein the screw connection also fixes the main body in the housing.

13. The machine tool according to claim 1, wherein the gap is narrower than or equal to 1 mm.

14. The machine tool according to claim 1, wherein the cooling device adjoins an inner ring of the bearing in an overlapping manner, at least in part in a direction of the axis of rotation.
